(19) United States
(12) Patent Application Publication
(10) Pub. No.: US 2002/0091877 A1
(43) Pub. Date: Jul. 11, 2002

(54) Wide screen notebook input/output device interface

(75) Inventor: John Peter Karidis, Ossining, NY (US)

Correspondence Address: John Bruce Schelkopf, IBM Corporation, Legal Dept., Dept. 9CCA/Bldg.002-2, Research Triangle Park, NC, 27709, US

(73) Assignee: International Business Machines Corporation, Armonk, NY (US)

(21) Appl. No.: 09/756,831

(22) Filed: Jan. 8, 2001

(51) Int. Cl. G06F 3/00

(52) U.S. Cl. 710/1

(57) ABSTRACT

A notebook computer with an extended keyboard base and widened display. The extended keyboard base region adjacent to the keyboard has a recessed area which contains a universal I/O connector. The recessed area is designed to fit a set of I/O devices which are designed to electrically connect to the universal I/O connector. When a I/O device is plugged into the universal I/O connector, it may be automatically sensed by circuitry internal to the notebook computer and software drivers are loaded that enables the particular I/O device to be used. The widened display gives added display capability wherein multiple pages of a document may be placed side by side for editing or viewing. I/O devices include, but are not limited to, a numeric keypad, a trackpad/digitizer, a track pad with integrated display, a WorkPad, a digital camera pad, a MP3Pad, a Fingerprint sensor, Control Pad, a PhonePad, a Cellular Pad, and a SmartCard reader/recorder.

### TECHNICAL FIELD

The present invention relates in general to notebook size computers and in particular to the physical and signal interface of removable input/output (I/O) devices to a notebook computer.

### BACKGROUND INFORMATION

Notebook computers have wide usage and are usually selected for their small size. Sometimes an application for a notebook computer does not require the smallest size but rather requires portability and the ability to add options when needed. Notebook computers typically require cabling to add some optional devices (e.g., printers and larger displays) which plug into ports that have the appropriate connector for the particular option. Other optional devices may be self contained (e.g. auxiliary storage units) and plug into a compatible connector and reside inside the notebook computer. One of the limitations of notebook computers is their small display screen size and small keyboard size. To remedy this problem some notebook computers have been made with means to expand the keyboard from a smaller stored form factor and many notebook computers have external display ports for optionally using an external display either concurrent with or instead of the attached display.

Traditionally, the keyboard area of a notebook has been reserved for devices that have an input only function, such as a keypad, track ball or other type of pointing device. There have also been notebook computers with printer ports and ports for connecting to a larger display, however, these devices are usually not portable and the I/O connections are generally in the back of the keyboard base. Recently digital devices have been introduced that have functionality when not connected to computer (e.g., digital cameras). However, these devices may have information that may be loaded into a computer for further processing or storage and may also receive output data from a computer. While these devices may have a standardized electrical interfaces (e.g., USB serial bus) their physical and electrical interface are not necessarily designed to make these I/O devices conveniently operate as part of the notebook computer.

Therefore, there is a need for a notebook computer with I/O device connectivity in combination with a widened display screen where the traditional features of the notebook are enhanced with the ability to connect new and existing I/O devices with a new display form factor.

### SUMMARY OF THE INVENTION

A notebook computer is disclosed with a keyboard base containing a keyboard and an attached display. The keyboard base is widened to create a widened I/O area. The display is also widened corresponding to the widened keyboard base. In one embodiment, a recessed area is provided within the widened I/O area which has an I/O connector adapted for a number of removable I/O devices. Each of the I/O devices is operable to electrically connect to the I/O connector. While the I/O devices may vary in functionality, they are all adapted to physically and electrically connect to the I/O connector. I/O devices may also have software drivers, necessary to interface to the notebook computer, either resident in the I/O device or in the notebook computer. Connection of an I/O device may automatically cause the I/O device drivers to be loaded into the notebook computer from the I/O device or the device drivers may be stored and activated from within the notebook computer itself. The widened display may use the extended display space to either display multiple windows for normal notebook operation or to display a window associated only with the operation of a particular I/O device installed in the recessed area in the widened keyboard base and connected to the I/O connector. Selected I/O devices may have functionality wholly separate from any communication or connection with the notebook computer.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a notebook computer with a widened display screen and how an I/O device may connect to an I/O connector in a widened keyboard base;

FIG. 2 illustrates a notebook computer with a widened display screen and an I/O device installed in the widened I/O area where the widened screen is used to display multiple windows side by side for a notebook computer application program;

FIG. 3 illustrates a notebook computer with a widened display screen and an I/O device installed in the widened I/O area where an I/O device window is show displayed in a widened portion of the notebook computer display;

FIG. 4 illustrates logic units and embodiments of the present invention useable in a notebook computer; and

FIG. 5 illustrates a flow diagram of method steps used in embodiments of the present invention.

### DETAILED DESCRIPTION

In the following description, numerous specific details are set forth to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like may have been omitted in as much as such details are not necessary to obtain a complete understanding of the present invention and are within the skills of persons of ordinary skill in the relevant art.

Refer now to the drawings wherein depicted elements are not necessarily shown to scale and wherein like or similar elements are designated by the same reference numeral through the several views. In the following description, the term I/O device will be synonymous with a “removable I/O device” as the invention is drawn to I/O devices that are removable from a notebook computer.

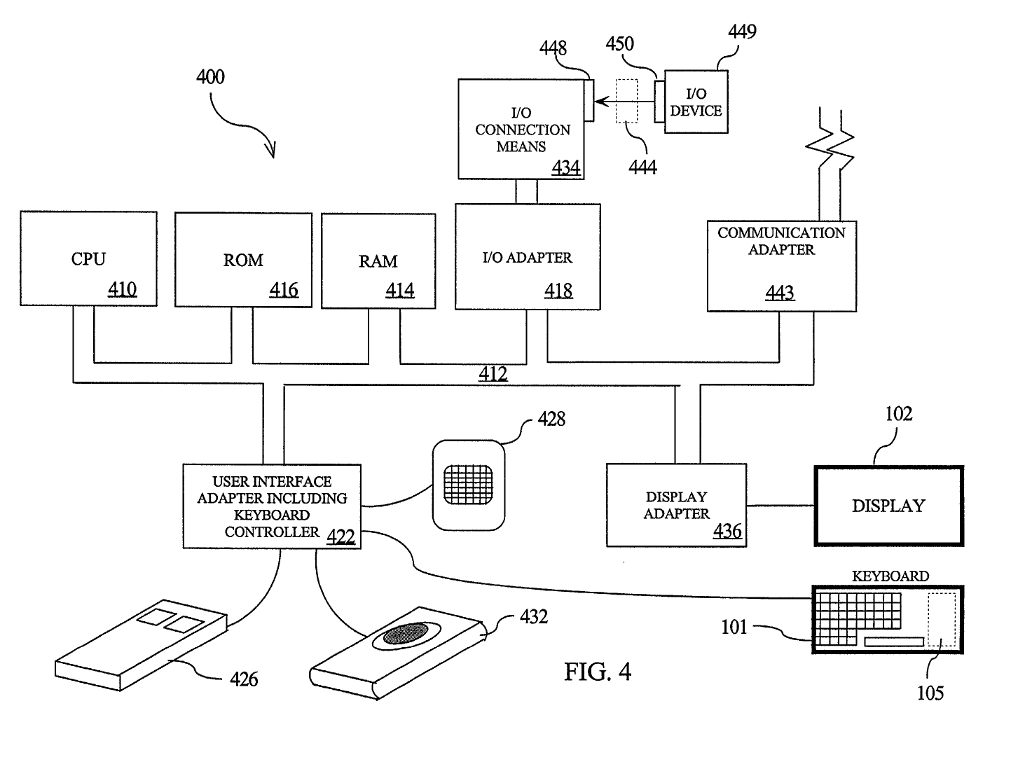

FIG. 4 is a block diagram of logic units within a motherboard 400 of a notebook computer (not shown in FIG. 4) useable with embodiments of the present invention. The central processing unit (CPU), read only memory (ROM) and random access memory (RAM) make up the majority of the processing function of the notebook computer. Bus 412 is one communication path used to communicate between the logic units and external devices. A user interface adapter 422 (including a keyboard controller) is used to couple signals from devices such as a keyboard 101, a mouse 426, a track ball 432 and an audio speaker 428. Keyboard 101 may have a widened keyboard base 107 with an widened I/O device area 108 according to embodiments of the present invention. A display adapter 436 is used to couple signals to a display 102. Display 102 may also have an widened display area 103 corresponding to a widened keyboard base 107 according to embodiments of the present invention. Bus 412 may also be used to couple signals from I/O adapter 418 and communication adapter 443. Adapters 418 is used, according to embodiments of the present invention, to couple signals from an I/O device 449 to motherboard 400 via I/O connection means 434. In one embodiment of the present invention, I/O device 449 has a connector 450 that is operable to mate with a corresponding connector 448 on I/O connection means 434. In another embodiment of the present invention, where connectors 448 and 450 are not matched, an interposer 444 is inserted between these two connectors to enable signal connection. Interposer 444 would have a connector features compatible with connector 450 on the I/O device 449 side and a connector feature compatible with connector 448 on the I/O connection means 434 side. The signals wires (not shown) within the interposer 444 would make the required corresponding signal connections to ensure operation of I/O device 449. An interposer 444 may also be used, in embodiments of the present invention, when the physical form of the connector on an I/O device 449 or a physical feature of the I/O device 449 itself does not allow connection of the I/O device 449 directly to the motherboard 400 via connector 448. Other communication signals from other devices (not shown) may be coupled to bus 412 via communication adapter 443.

Once CPU 410 recognizes a device by its identifying signals it may also have programs with instructions to retrieve, from RAM 414, ROM 416, or from the I/O device 449 itself, data specific to the operation of the identified I/O device 449. This data may include device driver instructions or other pertinent operational information. CPU 410 may also activate software routines that have instructions used to communicate with display adapter 436 to present, on an I/O device display window 111, data specific to the operation of a specific connected I/O device 449. This I/O device display window 111 may be wholly separate and not overlay any other operation windows (e.g., 109) on a display 102. An I/O device 449 with specific I/O device display window 111 may be used to indicate, to a user, operation status of I/O device 449. For example, I/O device display window 111 may indicate; whether a communication link has been established, any additional instructions to the user concerning actions to be taken, or it may be used to display I/O data in various forms. The I/O device display may also contain data which has been received from or is to be transmitted to I/O device 449.

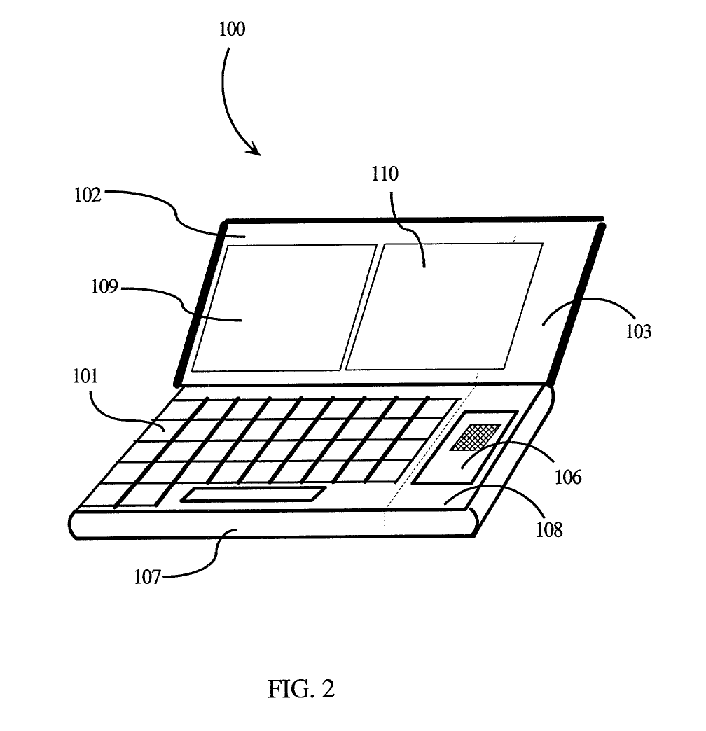

I/O device display window 111 may be used without interrupting other notebook computer display window information. Other embodiments of the present invention allow an widened display 102 (with a widened area 103) to be used by the CPU 410 to display windows (e.g., 109 and 110 in FIG. 2) of a notebook computer application program if no I/O device 449 is present an using the widened display area 103. An I/O device 449 may be self contained and be wholly operable as a stand alone device when not communicating with notebook computer devices via a motherboard 400. The I/O connection means 434 allows newly developed devices to be easily adapted to an existing notebook computer containing embodiments of the present invention.

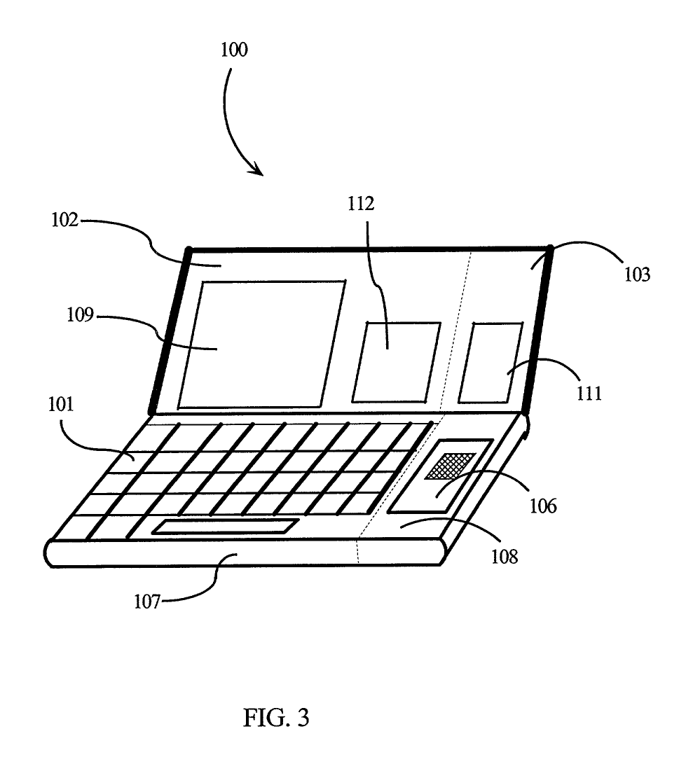

An I/O device 449 may be supplied with an interposer 444 to allow required signals to be coupled via an I/O adapter 418 and bus 412 to a CPU 410. Even though the new I/O device 449 was previously unknown, it may still be adaptable to load, into CPU 410, software that would fully enable synergistic operation of the I/O device 449 and a notebook computer with CPU 410. The downloaded software may have instructions operable for later identification of the I/O device 449 with display functions for the widened display area 103 (see FIG. 3).

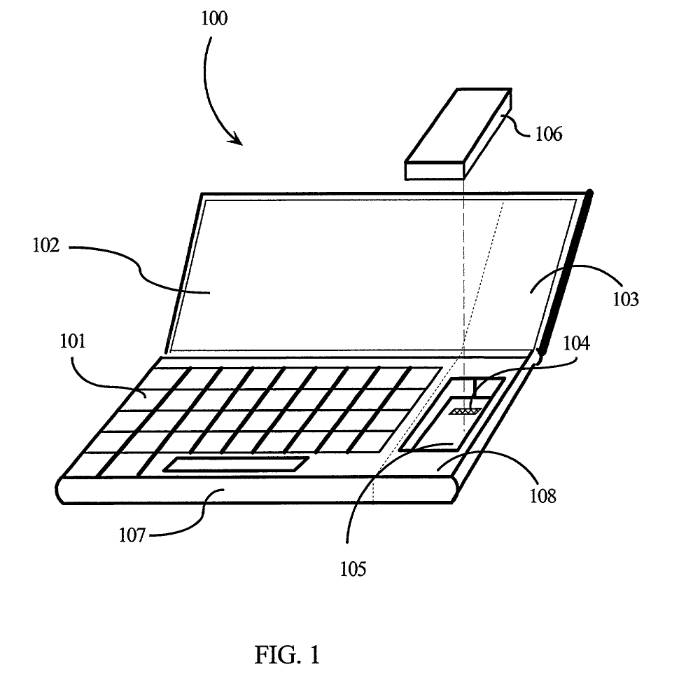

FIG. 1 is an illustration of a notebook computer comprising embodiments of the present invention. Notebook computer 100 has a keyboard 101 and display screen 102. Embodiments of the present invention widen the base 107 creating an widened area 108. Widened area 108 has a recessed I/O area 105 which contains I/O connection means 104. Recessed I/O area 105 is operable to accept one of a group of universal I/O devices 106. I/O devices 106 may be sized to fit into the I/O area 105 (or adapted possibly using an interposer) to mate with I/O connection means 104. Notebook computer 100 also has, as the result of extension of the base 107, an widened I/O display area 103. I/O display area 103 makes the display 102 more useable either by enabling a single very wide window, two or more smaller windows side-by side, or optionally an inserted window supporting an added I/O device installed or connected in recessed I/O area 105. I/O connection means 104 may contain sensing means to indicate to the central processing unit (CPU) of the notebook computer 100 the identity of an added I/O device 106, if necessary. The CPU (not shown, e.g., 410) may reside on a mother board (e.g., 400) which also contains necessary electronic circuits for the notebook computer 100. The CPU is operable to automatically load drivers and software necessary to support an added I/O device 106. The sensing means in the I/O connection means 104, in one embodiment of the present invention, may be a selected number of connector pins that receive encoded logic signals from the added I/O device and couple these signals to the CPU. In another embodiment of the present invention, an added I/O device 106 sends a serial set of bits defining its identity on a specific connector pin of the I/O connection means 104. Other sensing means, for determining an I/O device identity, may include applying a logic signal to a selected single pin which is coupled to the CPU which the CPU has been programmed to associate with a particular I/O device 106.

Many different I/O devices are possible using embodiments of the present invention. A list of possible I/O devices includes, but is not limited to, a numeric keypad, a trackpad/digitizer, a track pad with integrated display, a Work Pad or other personal digital assistant (PDA), a digital camera pad, a MP3 Pad, a Fingerprint sensor, Control Pad, a Phone Pad, a Cellular Pad, and a SmartCard reader/recorder. A “pad” in this context is a term used to define an I/O unit which has the features necessary to provide the particular I/O function (e.g., buttons, keys, audio input/output, display, etc.). A keypad may be a simple input device for inputting key data where the keypad has a particular keypad layout or specific user characters. A trackpad/digitizer may be a device that is used over a drawing where a reference may be established and data inputted by moving over figures and inputting coordinates of points. Some devices like a PDA or a digital camera pad may have a complete functionality wholly separate from communication to the notebook computer. A Phone Pad or Cellular Pad contain the functionality to make phone calls using either the standard telephone protocol or wireless via a cellular connection. The notebook may use the functionality of the Phone Pad or Cellular Pad to make either voice or data connections. For example a user may want to use the Cellular Pad in conjunction with the notebook computer to make a voice connection and talk while accessing and displaying data or operating an application program. Other devices like the Fingerprint sensor may be used for a variety of security protocol applications (e.g., granting access to certain local or remote files). A Smartcard reader/recorder is a device used to read and write specially formatted cards that may contain data storage either magnetically, optically or by accessing embedded memory chips within the Smartcard.

In one embodiment of the present invention, plugging in an I/O device 106 into I/O connection means 104 would trigger the enhanced notebook computer 100 to present a display window (e.g., 111) indicating which supported I/O device drivers are installed. The user would then select, from the options, the particular I/O device 106. In another embodiment of the present invention, the notebook computer automatically loads the appropriate I/O device driver by sensing the particular I/O device 106 connected. Yet in another embodiment of the present invention, the I/O device 106 stores its required I/O driver in internal ROM. The I/O driver may be automatically loaded into the notebook computer when the I/O device 106 is coupled to I/O connection means 104. Other embodiments of the present invention also bring up a supporting display window (e.g., 111) in the extended display area 103 for use with the I/O device 106. The extended display area 103 would also be available for notebook computer application program use whether or not an I/O device 106 is connected. This would be very useful for displaying two pages side by side during an editing or review process.

FIG. 2 illustrates an embodiment of the present invention of a notebook 100 with an installed I/O device 106. Widened keyboard base 107 contains a keyboard 101. Display 102 has an extended display area 103. In this illustration, two display windows 109 and 110 are shown displayed side by side where display window 110 extends into extended display area 103.

FIG. 3 illustrates an embodiment of the present invention where a notebook computer 100 has a I/O device 106 installed. Widened keyboard base 107 contains a keyboard 101. Display 102 has a widened display area 103. In this illustration, display windows 109 and 112 are in display 101. An I/O display window 111, associated with I/O device 106, is displayed in the widened display area 103.

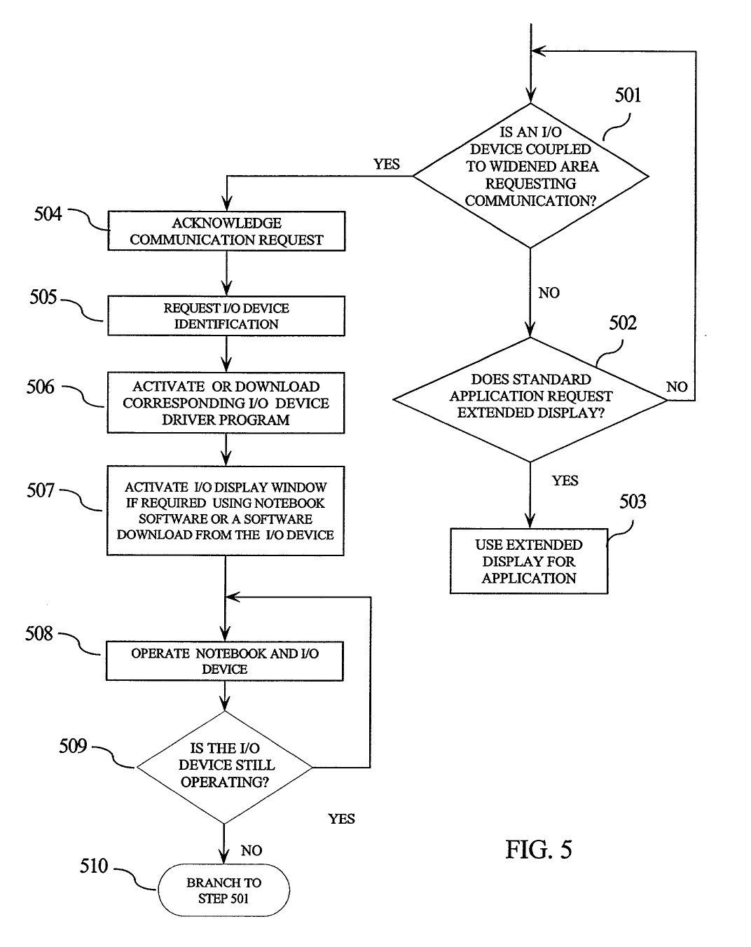

FIG. 5 is a flow diagram of method steps in embodiments of the present invention. In step 501, a test is executed to determine if a I/O device 106 is coupled to the universal connection means is sending communication requests. If the result of the test in 501 is NO, then a test is done in step 502 to determine if a notebook application program has a requirement that may use the widened display area 103. If the result of the test in step 502 is YES, then the widened display area 103 may be used for the notebook application program. If the result of the test in step 502 is NO, then a branch is executed to step 501 awaiting an I/O device 106 connection or a requirement by an notebook application program that may use of the widened display 103. If the result of the test in step 501 is YES, then communication requests of an activated and installed I/O device 106 are acknowledged in step 504. In step 505, communication software within the notebook computer 100 requests I/O device 106 identification. In step 506, the particular I/O device driver program is either downloaded to or activated within the notebook computer 100. In step 507, the I/O display window program is activated in the notebook or downloaded from the I/O device 106. In step 508, the notebook computer 100 and the I/O device 106 are operated together under user commands entered via the keyboard 101 of notebook computer 100 or via the I/O device 106. In step 509, a test is executed to determine if operation the I/O device 106 active or terminated. If the result of the test in step 509 is YES, a branch is executed back to step 508 continuing operation. If the result of the test in step 509 is NO, then a branch to step 501 is executed in step 510 awaiting communication requests from an I/O device.

Although the present invention and its advantages have been described in detail, it should be understood that various changes, substitutions and alterations can be made herein without departing from the spirit and scope of the invention as defined by the appended claims.

What is claimed is:

1. A notebook computer with an input/output (I/O) physical user interface comprising:
a base containing a keyboard for said notebook computer, wherein said base has an extended portion beyond said keyboard creating a widened keyboard base;
a widened display, said widened display having a widened I/O display area corresponding to said widened keyboard base, said widened display having a width substantially equal to a width of said widened keyboard base;
an I/O device area disposed within said extended portion of said widened keyboard base; and
an interface signal connection means mounted within said I/O device area, said interface signal connection means operable to couple signals from said notebook computer to an I/O device.

2. The notebook computer of claim 1, wherein said I/O device area is recessed below a surface of said I/O device area, said recessed I/O device area operable to receive said I/O device.

3. The notebook computer of claim 2, wherein said interface signal connection means is disposed within said recessed I/O device area.

4. The notebook computer of claim 1, wherein an interface connection interposer is disposed between said interface signal connection means and said I/O device.

5. The notebook computer of claim 4, wherein said interface connection interposer is disposed within said recessed I/O device area.

6. The notebook computer of claim 4, wherein said interface connection interposer is operable to compensate for both mechanical and signal routing differences between said universal connection means, said recessed I/O area and said I/O device.

7. The notebook computer of claim 1, wherein said widened I/O display area is used to display operational data relative to operation of said I/O device when said I/O device is sending or receiving signals to said notebook computer.

8. The notebook computer of claim 1, wherein said notebook computer is operable to execute first communication software instructions, said first communication software instructions controlling communication between said notebook computer and said I/O device.

9. The notebook computer of claim 1, wherein said I/O device is operable to execute second communication software instructions, said second communication software instructions controlling communication between said notebook computer and said I/O device.

10. The notebook computer of claim 1, wherein said I/O device has functionality wholly separate from any communication signaling or connection with said notebook computer.

11. A method of interfacing a I/O device to a notebook computer, comprising the steps of:
providing said notebook computer with a widened display and a widened keyboard base, said widened keyboard base having an I/O device area;
providing a signal connection means within said I/O device area;
coupling signals from said I/O device to I/O circuitry in said notebook computer, said I/O circuitry operable to couple signals from said I/O device to a central processing unit (CPU) in said notebook computer;
activating communication software, said communication software operable to control communication between said CPU and said I/O device; and
activating display software, said display software operable to execute instructions directing the display of input or output data relevant to said I/O device in a widened portion of said widened display.

12. The method of claim 11, further comprising the step of operating said notebook computer and said I/O device together in response to user commands entered via said notebook computer or via said I/O device.

13. The method of claim 11, wherein said widened display has a width substantially equal to a width of said widened keyboard base.

14. The method of claim 11, wherein said I/O device has functionality wholly separate from any communication signaling or connection with said notebook computer.
